(19) United States
(12) Patent Application Publication
(10) Pub. No.: US 2007/0123193 A1
(43) Pub. Date: May 31, 2007

(54) Portable terminal apparatus, computer-readable storage medium, and image display method

(75) Inventor: Yasuyuki Kitada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/357,120

(22) Filed: Feb. 21, 2006

(30) Foreign Application Priority Data
Nov. 22, 2005 (JP) 2005-337438

(51) Int. Cl. H04Q 7/20; H04M 11/00

(52) U.S. Cl. 455/403

(57) ABSTRACT

In response to two or more incomings-in-absence, a portable terminal apparatus displays, according to a predetermined order of priority, an image associated with the originator of an incoming-in-absence with the highest priority of the incomings-in-absence on a display screen. Also, in response to an image-canceling instruction, the apparatus cancels an image currently displayed on the display screen and displays an image associated with the originator of an incoming-in-absence with the highest priority next to the incoming with the cancelled image of the incomings-in-absence.

### BACKGROUND OF THE INVENTION

1. Field of the Invention

The present invention relates to a portable terminal apparatus capable of performing wireless communications such as a portable telephone, a computer-readable storage medium that stores an incoming-in-absence processing program to be executed in the portable terminal apparatus, and an image display method of displaying an image for calls/emails arrived in absence in the portable terminal apparatus.

2. Description of the Related Art

In recent years, portable telephones have become widespread and users frequently make a telephone call and exchange emails using their portable telephones. In many cases, users of the portable telephones may be unable to promptly answer an incoming call or read an incoming email when the telephone is left somewhere or even when it is carried.

Considering such situations, some portable telephones are made to have a system of displaying a message that notifies a user of a call or email arrived in his/her absence if the user gives no prompt response to such an arrived call or email. By looking at the displayed message, the user can check the information about the originator, the contents of the arrived email, etc. through some operations at a later time.

There is also known a technique for notifying a user that a call or email has arrived in his/her absence by displaying a certain image associated with an originator's number instead of displaying a message (see Japanese Patent Application Publication No. 2003-333137).

In the system of displaying a message that notifies a user of a call or email arrived in his/her absence, the user can recognize an originator only by checking the information about the originator or opening the email through some required operations. Therefore, the user has to carry out such operations even when the user only wants to know who the originator is and there is no need to answer the arrived call or to check the contents of the email, which is inconvenient.

In contrast, the technique disclosed in Japanese Patent Application Publication No. 2003-333137 enables a user to recognize the originator of a call/email arrived in his/her absence only by looking at the displayed image associated with the originator, which is desirable. However, this is a technique that allows a user to promptly recognize the originator of only one call or email arrived in his/her absence, not the originators of two or more calls or emails arrived in his/her absence.

Under such circumstances, the present invention provides a portable terminal apparatus such as a portable telephone for example, which enables a user to readily recognize the respective originators of two or more calls or emails arrived in the user's absence. The invention also provides a computer-readable storage medium that stores an incoming-in-absence processing program and an image display method, which implements such a portable terminal apparatus.

### SUMMARY OF THE INVENTION

In view of the foregoing, the present invention provides a portable terminal apparatus capable of performing wireless communications, including:

an association storing section which stores images associated with the originators of incomings-in-absence to which no operation according to incoming is performed, each of the images to be displayed in response to an incoming-in-absence;

an image display section which has a display screen and displays, in response to an incoming-in-absence, an image associated with the originator of the incoming-in-absence and stored in the association storing section on the display screen; and

an image-cancellation instructing section which causes, in response to an operation for canceling an image associated with the originator of an incoming-in-absence and displayed on the display screen, the image display section to cancel the image displayed,

wherein in response to plural incomings-in-absence, the image display section displays an image associated with the originator of an incoming with the highest priority of the plural incomings-in-absence on the display screen according to a predetermined order of priority, and wherein the image display section cancels an image currently displayed on the display screen upon receipt of an image-canceling instruction from the image-cancellation instructing section and displays an image associated with the originator of an incoming with the highest priority next to the incoming associated with the cancelled image of the plural incomings-in-absence.

The portable terminal apparatus of the invention displays an image with the highest priority in response to two or more incomings-in-absence. When the displayed image is cancelled in response to a cancellation operation, the apparatus displays an image with the next highest priority. Therefore, the apparatus makes it possible to readily and sequentially recognize the originators of the incomings-in-absence.

The portable terminal apparatus may be such that in response to plural incomings-in-absence, the image display section assigns ascending priorities to plural incomings-in-absence in chronological order and displays an image associated with the originator of the latest incoming-in-absence.

Further, the portable terminal apparatus may be such that the association storing section stores images and originators associated with each other and stores priorities assigned to the originators, and

in response to plural incomings-in-absence, the image display section displays an image associated with an originator with the highest priority of the originators of the plural incomings-in-absence on the display screen according to the priorities stored in the association storing section.

Furthermore, the portable terminal apparatus may further include a function of receiving calls and a function of receiving emails,

wherein the association storing section stores priorities assigned to the function of receiving calls and the function of receiving emails, and

wherein upon receipt of both a call-in-absence and an email-in-absence, the image display section displays an image associated with the originator of one with a higher priority of the call-in-absence and the email-in-absence on the display screen according to the priorities stored in the association storing section.

Still furthermore, the portable terminal apparatus may be such that upon cancellation of all images associated with originators of incomings-in-absence, the image display section displays a predetermined standby image on the display screen.

The present invention also provides a computer-readable storage medium which stores an incoming-in-absence processing program that causes a computer to operate as a portable terminal apparatus capable of performing wireless communications when executed in the computer, the portable terminal apparatus including:

an association storing section which stores images associated with the originators of incomings-in-absence to which no operation according to incoming is performed, each of the images to be displayed in response to an incoming-in-absence;

an image display section which has a display screen and displays, in response to an incoming-in-absence, an image associated with the originator of the incoming-in-absence and stored in the association storing section on the display screen; and

an image-cancellation instructing section which causes, in response to an operation for canceling an image associated with the originator of an incoming-in-absence and displayed on the display screen, the image display section to cancel the image displayed,

wherein in response to plural incomings-in-absence, the image display section displays an image associated with the originator of an incoming with the highest priority of the plural incomings-in-absence on the display screen according to a predetermined order of priority, and wherein the image display section cancels an image currently displayed on the display screen upon receipt of an image-canceling instruction from the image-cancellation instructing section and displays an image associated with the originator of an incoming with the highest priority next to the incoming associated with the cancelled image of the plural incomings-in-absence.

The computer-readable storage medium may be such that in response to plural incomings-in-absence, the image display section assigns ascending priorities to plural incomings-in-absence in chronological order and displays an image associated with the originator of the latest incoming-in-absence.

Further, the computer-readable storage medium may be such that the association storing section stores images and originators associated with each other and stores priorities assigned to the originators, and

in response to plural incomings-in-absence, the image display section displays an image associated with an originator with the highest priority of the originators of the plural incomings-in-absence on the display screen according to the priorities stored in the association storing section.

Furthermore, the computer-readable storage medium may be such that the portable terminal apparatus further includes a function of receiving calls and a function of receiving emails,

wherein the association storing section stores priorities assigned to the function of receiving calls and the function of receiving emails, and

wherein upon receipt of both a call-in-absence and an email-in-absence, the image display section displays an image associated with the originator of one with a higher priority of the call-in-absence and the email-in-absence on the display screen according to the priorities stored in the association storing section.

Still furthermore, the computer-readable storage medium may be such that upon cancellation of all images associated with originators of incomings-in-absence, the image display section displays a predetermined standby image on the display screen.

The present invention also provides an image display method of displaying an image on a portable terminal apparatus capable of performing wireless communications, the method including:

an association storing step which stores images associated with the originators of incomings-in-absence to which no operation according to incoming is performed, each of the images to be displayed in response to an incoming-in-absence; and

an image display step which displays, in response to an incoming-in-absence, an image associated with the originator of the incoming-in-absence and stored in the association storing step on a display screen, and which cancels, in response to an operation for canceling an image associated with the originator of an incoming-in-absence and displayed on the display screen, the image displayed,

wherein in response to plural incomings-in-absence, the image display step displays an image associated with the originator of an incoming with the highest priority of the plural incomings-in-absence on the display screen according to a predetermined order of priority, and wherein the image display step cancels an image currently displayed on the display screen upon receipt of an image-canceling instruction from the image-cancellation instructing section and displays an image associated with the originator of an incoming with the highest priority next to the incoming associated with the cancelled image of the plural incomings-in-absence.

As described above, it is possible to readily recognize the originators of incomings-in-absence according to the present invention.

### BRIEF DESCRIPTION OF THE DRAWINGS

FIG. 1 is an external perspective view of a portable terminal apparatus according an embodiment of the invention, as viewed from the front;

FIG. 2 is an external perspective view of the portable terminal apparatus shown in FIG. 1, as viewed from the back;

FIG. 3 is a circuit block diagram of the portable terminal apparatus shown in FIGS. 1 and 2;

FIG. 4 shows various examples of standby images;

FIG. 5 is a table showing an extended telephone number book;

FIG. 6 is a table showing priority levels between a telephone function and an email function;

FIG. 7 is a flowchart of a program to be executed at the time of receiving data (when a call/email arrives);

FIG. 8 is an incoming-in-absence listing table to be created when two or more calls/emails sequentially arrive;

FIG. 9 is a flowchart showing how a call/email arrived in absence is cancelled; and

FIG. 10 is a diagram showing how the display screen changes at the time of canceling calls/emails arrived in absence.

### DETAILED DESCRIPTION OF THE INVENTION

An embodiment of the present invention will be described.

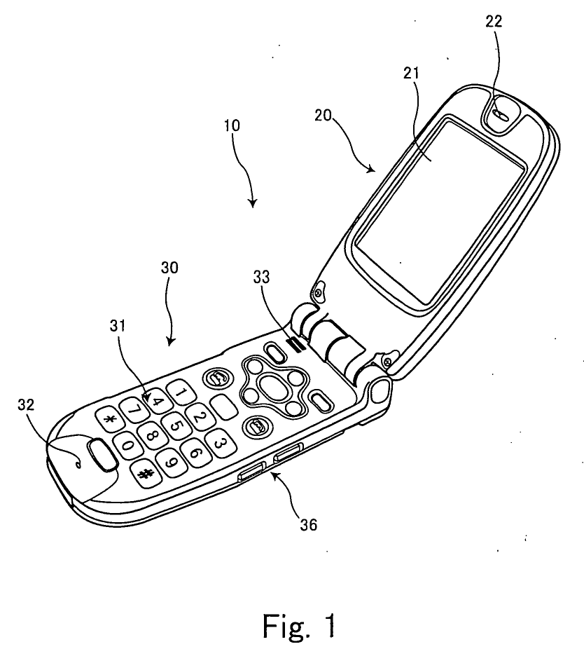

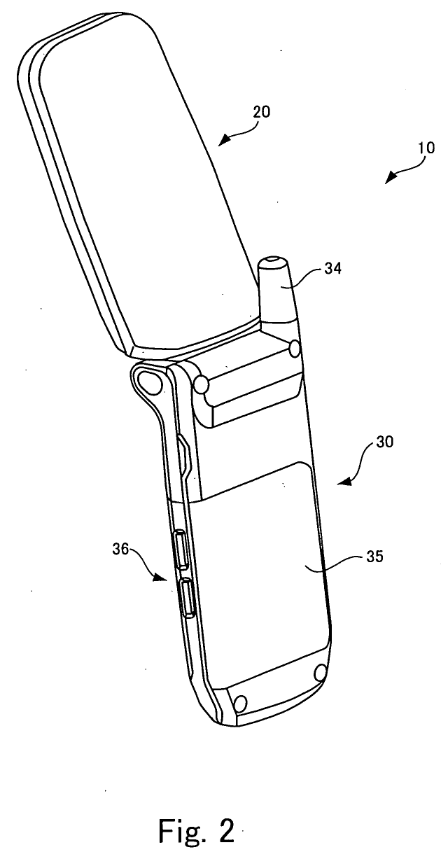

FIG. 1 is an external perspective view of a portable terminal apparatus 10 according an embodiment of the invention, as viewed from the front. FIG. 2 is an external perspective view of the portable terminal apparatus 10 shown in FIG. 1, as viewed from the back.

The portable terminal apparatus 10 is comprised of an upper case 20 and a lower case 30 which are openable and closable with respect to each other. As shown in FIG. 1, the front of the portable terminal apparatus 10 is provided with a screen display window 21 for displaying images and covered with a window member such as a transparent acrylic plate and an earpiece 22 having a small speaker therein and transmitting a sound when brought near to a user's ear.

As shown in FIG. 1, the lower case 30 has multiple operating buttons 31 on the front and a small microphone in the inside. The lower case 30 also has a mouthpiece 32 for transmitting user's voice to the microphone and a sound outlet 33 for sending out a sound emitted from a speaker disposed at the back thereof, which sound is loud enough to hear without bringing the apparatus close to an ear. Meanwhile, as shown in FIG. 2, the back of the lower case 30 is provided with an antenna 34 and a battery lid 35 for covering a battery being inserted into a battery chamber formed inside. Further, operating buttons 36 are disposed on a frank of the lower case 30. The portable terminal apparatus 10 shown in FIGS. 1 and 2 is capable of sending/receiving calls and emails.

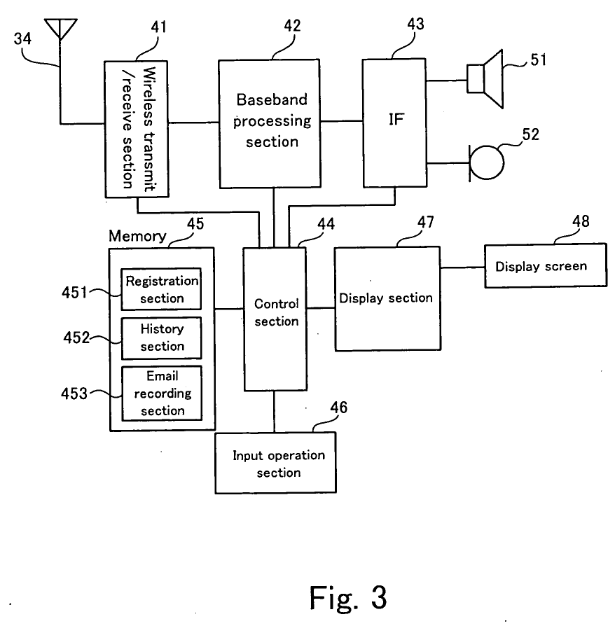

FIG. 3 is a circuit block diagram of the portable terminal apparatus 10 shown in FIGS. 1 and 2.

FIG. 3 shows a wireless transmit/receive section 41, a baseband processing section 42, and an interface (I/F) section 43.

The wireless transmit/receive section 41 is a block for wirelessly transmitting and receiving signals via the antenna 34 (also referred to FIG. 2).

The baseband processing section 42 is a block for subjecting signals to processing such as frequency conversion between a frequency band for wireless communications and a frequency band for sounds etc.

The interface section 43 is a block for transmitting signals between the baseband processing section 42 and a speaker 51 as well as a microphone 52.

The wireless transmit/receive section 41, baseband processing section 42, and interface section 43 are all connected to and controlled by a control section 44 while operating.

In addition, a memory 45, an input operation section 46, and a display section 47 are also connected to the control section 44.

The memory 45 includes: a registration section 451 for storing various kinds of information such as telephone numbers, email addresses, and images; a history section 452 for storing various kinds of historical data such as an incoming-call/email history and a outgoing-call/email history; and an email recording section 453 for recording emails. The embodiment will focus on calls/mails arrived in absence. Images to be displayed at the time of receiving a call/email in absence and information such as priority levels are stored in the registration section 451, and an incoming-in-absence history is stored in the history section 452.

Writing and reading information into and out from the memory 45 are controlled by the control section 44.

The input operation section 46 is a block for transmitting information about operations of the operating buttons 31 and 36 shown in FIGS. 1 and 2 to the control section 44.

The display section 47 is a block for displaying data sent from the control section 44 on a display screen 48 after converting the data into signals for display.

The display screen 48 is seen through the screen display window 21 shown in FIG. 1.

For a telephone call, the following processing is performed under the control of the control section 44. A radio signal picked up by the antenna 34 is first received by the wireless transmit/receive section 41, subjected to processing by the baseband processing section 42, and then transmitted to the speaker 51 via the interface section 43 to be output as a sound. A sound picked up by the microphone 52 is first transmitted to the baseband processing section 42 via the interface section 43, subjected to signal conversion for wireless transmission by the baseband processing section 42, and then wirelessly transmitted by the wireless transmit/receive section 41 via the antenna 34.

At this point, if a user gives no response to an incoming call through the input operation section 46, the control section 44 searches the registration section 451 of the memory 45 for a telephone number matching the telephone number of the originator of the incoming call, reads out and sends an image associated with the matched telephone number to the display section 47. The display section 47 then displays the received image on the display screen 48. The control section 44 writes the information about the originator of the incoming call into the incoming-in-absence history of the history section 452.

Meanwhile, the following processing is performed if an email arrives. First, a signal of the arrived email is picked up by the antenna 34 and then received by the wireless transmit/receive section 41. Subsequently, the received signal is sent to the baseband processing section 42 where the signal is subjected to processing for email receipt. The arrived email is then recorded into the email recording section 453 of the memory 45 by the control section 44. Simultaneously with the recording of the email, the information about the originator of the email is recorded into the incoming-in-absence history of the history section 452. Further, the control section 44 reads out an image associated with the originator and stored in the registration section 451 of the memory 45 and sends the read image to the display section 47 that displays the received image on the display screen 48. An image displayed on the display screen 48 can be cancelled by operating the input operation section 46. Such image display and cancellation will be described later in detail.

Meanwhile, a massage can be input through the input operation section 46, which is transmitted as an email via the control section 44, baseband processing section 42, wireless transmit/receive section 41, and antenna 34.

Now, there will be mainly described the details of processing related to calls and emails arrived in absence.

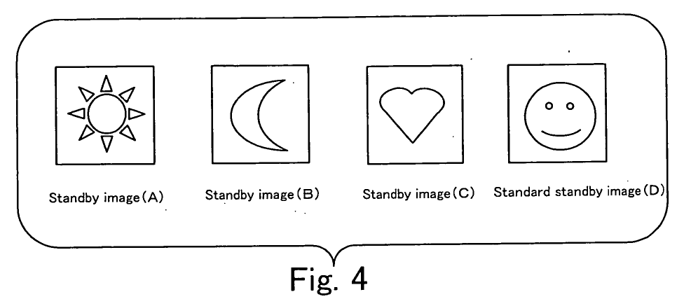

FIG. 4 shows various examples of standby images.

Standby images (A) through (C) are pictures of certain persons or illustrations reminding a user of certain persons. The standby images (A) through (C) are displayed at the time of receiving an incoming call or email. The image (D) is a standard standby image that is selected by a user and displayed regardless of incoming calls/emails-in-absence, or displayed after all the incoming calls/emails-in-absence are cancelled.

The standby images (A) through (C) and the standard standby image (D) shown in FIG. 4 are stored in the registration section 451 of the memory 45 as image data.

The standby images shown in FIG. 4 are examples and more standby images may be stored, added or deleted.

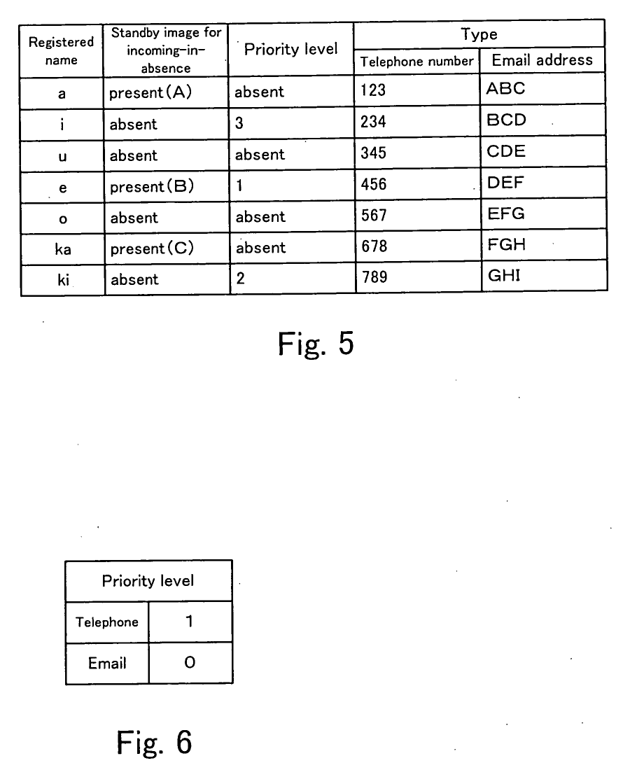

FIG. 5 is a table showing an extended telephone number book.

Although the table shown in FIG. 5 includes not only telephone numbers but also various kinds of information such as those described below, the table will be hereinafter refereed to as a “phone-number book.”

The phone-number book shown in FIG. 5 records data listed in items of “Registered name,” “Standby image for incoming-in-absence,” “Priority level,” and “Type” (“Telephone number” and “Email address”), which are associated with each other.

The “Registered name” includes names and nicknames of persons having the telephone number and email address. Merely “a,” “i,” “u,” “e,” “o,” “ka,” and “ki” are shown in FIG. 5 for convenience.

What specified in the “Standby image for incoming-in-absence” are images and the presence or absence of images each to be displayed when there is no prompt response to an incoming call or email sent from the corresponding originator listed in the “Registered name.”

The “Priority level” shows priority levels of images to be displayed on the display screen when two or more calls or emails arrive in absence. For example, the name “i” is associated with “3” and the name “e” is associated with “1” and therefore, if calls from the names “i” and “e” arrive, the standby image (B) associated with “e” is displayed.

Further, those listed in the “Telephone number” and “Email address” are telephone numbers and email addresses associated with the respective names listed in the “Registered name.”

The phone-number book shown in FIG. 5 is created by operations through the input operation section 46 shown in FIG. 3 and may be changed.

FIG. 6 is a table showing priority levels between a telephone function and an email function.

The number “1” is allocated to one with the higher priority (telephone in this example) whereas the number “0” is allocated to the other with the lower priority (email in this example). The number “0” may be allocated to both of them to set no priority levels.

As with the phone-number book shown in FIG. 5, the table of priority levels shown in FIG. 6 is created by operations through the input operation section 46 and stored in the registration section 451 of the memory 45 shown in FIG. 3.

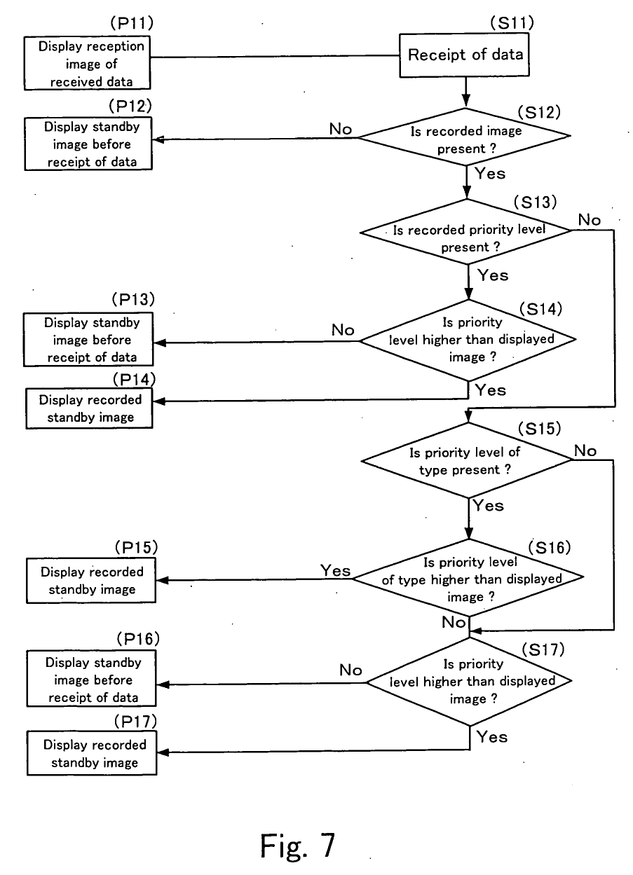

FIG. 7 is a flowchart of a program to be executed at the time of receiving data (when a call/email arrives). This program is executed by the control section 44 shown in FIG. 3.

Before receiving data, i.e. before the flow shown in FIG. 7 starts, the standard standby image (D) (see FIG. 4) is displayed on the display screen if there is no incoming call/email in absence at this point. If an incoming call/email arrives in absence at this point, one of the standby images (A) through (C) according to the originator of the call/email is displayed.

Upon receipt of data (call or email) (step S11), a reception image representing the receipt of data is displayed on the display screen (step P11). The reception image is an image for notifying a user of the receipt of data and stored in the registration section 451 of the memory 45 shown in FIG. 3 although it is omitted in the drawings.

While the reception image is displayed on the display screen for a predetermined period of time, if a user does not respond to the received data (by answering the call or opening the email), the flow proceeds to incoming-in-absence processing. In the incoming-in-absence processing, first, it is determined whether an image associated with the originator of the received data is recorded or not (step S12, also see FIG. 5). If there is no recorded image, the flow goes back to the standby image displayed before the arrival of the data (step P12).

On the other hand, if there is a recorded image (step S12), it is subsequently determined whether a priority level associated with the originator of the received data is recorded or not (step S13).

If there is a recorded priority level, the flow goes to step S14 where it is determined whether or not the priority level of the originator of the received data is higher than that of the standby image currently being displayed. If the result is No at step S14, the standby image currently being displayed, which is a standby image displayed before the arrival of the data (here, the reception image that is temporarily displayed is omitted for convenience in explanation), is continuously displayed (step P13). On the other hand, if the result is Yes at step S14, the standby image recorded as an image associated with the originator of the received data is displayed (step P14).

Meanwhile, if there is no recorded priority level (see FIG. 5) at step S13, the flow goes to step S15 where it is determined whether the priority levels between types (telephone number and email address) are set or not (see FIG. 6).

If the result is Yes at step S15, the flow goes to step S16 where it is determined whether or not the priority level assigned to the type of the received data is higher than that of the standby image currently being displayed. If the result is Yes at step S16, the standby image recorded as an image associated with the originator of the received data is displayed (step P15).

On the other hand, if the result is No at step S16 or at step S15, the flow goes to step S17 where it is determined, according to the priority levels shown in the table in FIG. 5, whether or not the priority level of the originator of the received data is higher than that of the standby image currently being displayed. If the result is No at step S17, the standby image currently being displayed, which is the standby image displayed before the arrival of the data, is continuously displayed (step P16). If the result is Yes at step S17, the standby image recorded as an image associated with the originator of the received data is displayed (step P17). When two or more calls/emails having the same priority level (or no priority level) are received in absence, it is preferable that a higher priority is placed on a later one of the received calls/emails.

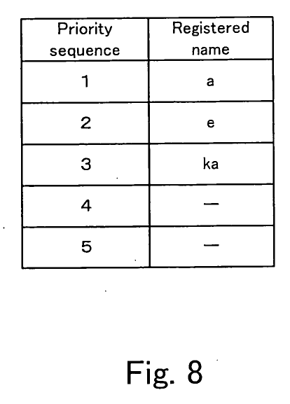

FIG. 8 is an incoming-in-absence listing table to be created when two or more calls/emails sequentially arrive in absence. The incoming-in-absence listing table is created in the history section 452 of the memory 45 shown in FIG. 3.

It is assumed here that three calls/emails are sequentially received and a table shown in FIG. 8 is created where the standby image (A) associated with the registered name “a” is provided with “1” meaning the highest priority and displayed on the display screen.

The example shown in FIG. 8 takes place when a call from the name “a” arrives in absence and sequentially emails from the names “e” and “ka” arrive in absence under the condition that “telephone” is higher than “mail” in priority as shown in FIG. 6.

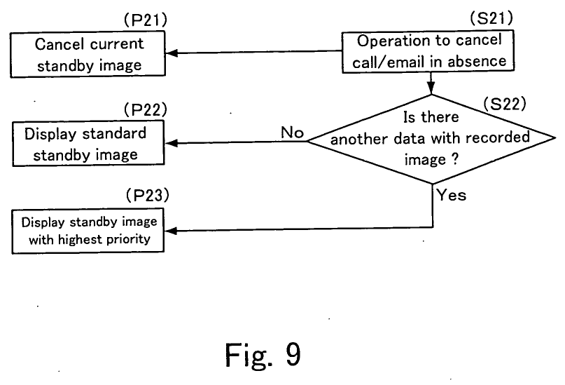

FIG. 9 is a flowchart showing how a call/email arrived in absence is cancelled.

In response to a user's operation for canceling a call/email arrived in absence (either an operation for checking the contents of a call/e-mail or an operation for canceling a call/e-mail without checking the contents) through the input operation section 46 (step S21), a standby image currently being displayed on the display screen is cancelled (step P21). As a result, the incoming-in-absence listing table shown in FIG. 8 is updated. Further, it is determined whether or not there is another data arrived in absence having a recorded image associated therewith (step S22). If the result is No at step S22, the standard standby image (D) (see FIG. 4) is displayed (step P22). If the result is Yes at step S22, the standby image of one with the highest priority among the remaining data is displayed (step P23).

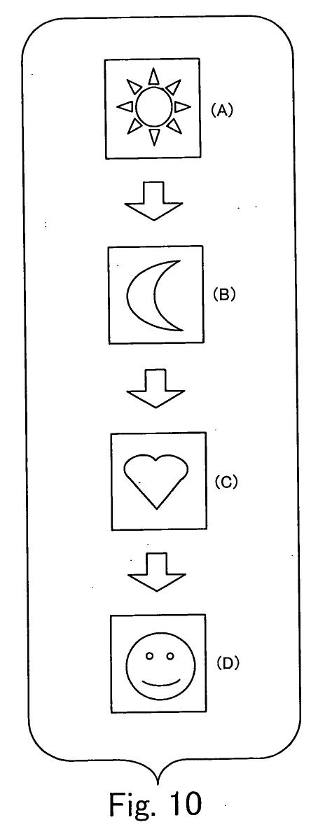

FIG. 10 is a diagram showing how the display screen changes at the time of canceling calls/emails arrived in absence.

In this figure, first, the standby image (A) associated with the registered name “a” is displayed on the display screen. At this point, if the call/email associated with this image (A) is cancelled, the standby image (B) associated with the registered name “e” is subsequently displayed. If the call/email associated with the image (B) is cancelled at this point, the standby image (C) associated with the registered name “ka” is subsequently displayed. Further, if the call/email associated with the image (C) is cancelled, the standard standby image (D) is subsequently displayed.

As described above, even when there are two or more calls/emails arrive in absence, it is possible to readily recognize the standby images associated with the respective received calls/emails according to the order of

What is claimed is:

1. A portable terminal apparatus capable of performing wireless communications, comprising:
an association storing section which stores images associated with the originators of incomings-in-absence to which no operation according to incoming is performed, each of the images to be displayed in response to an incoming-in-absence;
an image display section which has a display screen and displays, in response to an incoming-in-absence, an image associated with the originator of the incoming-in-absence and stored in the association storing section on the display screen; and
an image-cancellation instructing section which causes, in response to an operation for canceling an image associated with the originator of an incoming-in-absence and displayed on the display screen, the image display section to cancel the image displayed,
wherein in response to plural incomings-in-absence, the image display section displays an image associated with the originator of an incoming with the highest priority of the plural incomings-in-absence on the display screen according to a predetermined order of priority, and wherein the image display section cancels an image currently displayed on the display screen upon receipt of an image-canceling instruction from the image-cancellation instructing section and displays an image associated with the originator of an incoming with the highest priority next to the incoming associated with the cancelled image of the plural incomings-in-absence.

2. The portable terminal apparatus according to claim 1, wherein in response to plural incomings-in-absence, the image display section assigns ascending priorities to plural incomings-in-absence in chronological order and displays an image associated with the originator of the latest incoming-in-absence.

3. The portable terminal apparatus according to claim 1, wherein the association storing section stores images and originators associated with each other and stores priorities assigned to the originators, and
in response to plural incomings-in-absence, the image display section displays an image associated with an originator with the highest priority of the originators of the plural incomings-in-absence on the display screen according to the priorities stored in the association storing section.

4. The portable terminal apparatus according to claim 1, further comprising a function of receiving calls and a function of receiving emails,
wherein the association storing section stores priorities assigned to the function of receiving calls and the function of receiving emails, and
wherein upon receipt of both a call-in-absence and an email-in-absence, the image display section displays an image associated with the originator of one with a higher priority of the call-in-absence and the email-in-absence on the display screen according to the priorities stored in the association storing section.

5. The portable terminal apparatus according to claim 1, wherein upon cancellation of all images associated with originators of incomings-in-absence, the image display section displays a predetermined standby image on the display screen.

6. A computer-readable storage medium which stores an incoming-in-absence processing program that causes a computer to operate as a portable terminal apparatus capable of performing wireless communications when executed in the computer, the portable terminal apparatus comprising:
an association storing section which stores images associated with the originators of incomings-in-absence to which no operation according to incoming is performed, each of the images to be displayed in response to an incoming-in-absence;
an image display section which has a display screen and displays, in response to an incoming-in-absence, an image associated with the originator of the incoming-in-absence and stored in the association storing section on the display screen; and
an image-cancellation instructing section which causes, in response to an operation for canceling an image associated with the originator of an incoming-in-absence and displayed on the display screen, the image display section to cancel the image displayed,
wherein in response to plural incomings-in-absence, the image display section displays an image associated with the originator of an incoming with the highest priority of the plural incomings-in-absence on the display screen according to a predetermined order of priority, and wherein the image display section cancels an image currently displayed on the display screen upon receipt of an image-canceling instruction from the image-cancellation instructing section and displays an image associated with the originator of an incoming with the highest priority next to the incoming associated with the cancelled image of the plural incomings-in-absence.

7. The computer-readable storage medium according to claim 6, wherein in response to plural incomings-in-absence, the image display section assigns ascending priorities to plural incomings-in-absence in chronological order and displays an image associated with the originator of the latest incoming-in-absence.

8. The computer-readable storage medium according to claim 6, wherein the association storing section stores images and originators associated with each other and stores priorities assigned to the originators, and
in response to plural incomings-in-absence, the image display section displays an image associated with an originator with the highest priority of the originators of the plural incomings-in-absence on the display screen according to the priorities stored in the association storing section.

9. The computer-readable storage medium according to claim 6, wherein portable terminal apparatus further comprises a function of receiving calls and a function of receiving emails,
wherein the association storing section stores priorities assigned to the function of receiving calls and the function of receiving emails, and
wherein upon receipt of both a call-in-absence and an email-in-absence, the image display section displays an image associated with the originator of one with a higher priority of the call-in-absence and the email-in-absence on the display screen according to the priorities stored in the association storing section.

10. The computer-readable storage medium according to claim 6, wherein upon cancellation of all images associated with originators of incomings-in-absence, the image display section displays a predetermined standby image on the display screen.

11. An image display method of displaying an image on a portable terminal apparatus capable of performing wireless communications, the method comprising:
an association storing step which stores images associated with the originators of incomings-in-absence to which no operation according to incoming is performed, each of the images to be displayed in response to an incoming-in-absence; and
an image display step which displays, in response to an incoming-in-absence, an image associated with the originator of the incoming-in-absence and stored in the association storing step on a display screen, and which cancels, in response to an operation for canceling an image associated with the originator of an incoming-in-absence and displayed on the display screen, the image displayed,
wherein in response to plural incomings-in-absence, the image display step displays an image associated with the originator of an incoming with the highest priority of the plural incomings-in-absence on the display screen according to a predetermined order of priority, and wherein the image display step cancels an image currently displayed on the display screen upon receipt of an image-canceling instruction from the image-cancellation instructing section and displays an image associated with the originator of an incoming with the highest priority next to the incoming associated with the cancelled image of the plural incomings-in-absence.
